(19) United States
(12) Patent Application Publication
(10) Pub. No.: US 2002/0131113 A1
(43) Pub. Date: Sep. 19, 2002

(54) Modular design for optical subsystems and method of use

(76) Inventor: Chih-Hao Chen-hao, Huntington Beach, CA (US)

Correspondence Address: VOLENTINE FRANCOS, PLLC, SUITE 150, 12200 SUNRISE VALLEY DRIVE, RESTON, VA, 20191, US

(21) Appl. No.: 09/978,185

(22) Filed: Oct. 15, 2001

Related U.S. Application Data
(60) Provisional application No. 60/276,134, filed on Mar. 16, 2001.
(60) Provisional application No. 60/276,132, filed on Mar. 16, 2001.

(51) Int. Cl. H04J 14/02; H04B 10/04

(52) U.S. Cl. 359/124; 359/180

(57) ABSTRACT

According to an exemplary embodiment of the present invention, an optical apparatus includes a first bus having a plurality of modules connected thereto. At least one of the modules further includes at least one optical device which is connected to a second bus which is of the same protocol as the first bus.

According to another exemplary embodiment of the present invention, a method of accessing a plurality of optical devices includes providing a first access syntax to a host processor; and providing a second access syntax which translates the first access syntax. The second access syntax selectively enables access to the plurality of optical devices.

### CROSS REFERENCE TO RELATED APPLICATIONS

The present invention claims priority under 35 U.S.C §119(e) of U.S. Provisional Patent Application No. 60/276,134 filed Mar. 16, 2001 and entitled “Dual Interface Bus Design for Multi-Channeled Transmitter Based Subsystem”; and from U.S. Provisional Application Serial No. 60/276,132 filed Mar. 16, 2001 and entitled “Virtual Channel Access and Modular Design For DWDM Subsystems.” The disclosures of the above-captioned provisional applications are specifically incorporated herein by reference and for all purposes.

### FIELD OF THE INVENTION

The present invention relates generally to optical communications systems, and particularly to a modular design for subsystems and a method of implementation thereof.

### BACKGROUND OF THE INVENTION

The increasing demand for high-speed voice and data communications has led to an increased reliance on optical communications, particularly optical fiber communications. The use of optical signals as a vehicle to carry information at high speeds is preferred in many instances to carrying information at other electromagnetic wavelengths/frequencies in media such as microwave transmission lines, co-axial cable lines and twisted-pair transmission lines. Advantages of optical media are, among others, higher bandwidth, greater immunity to electromagnetic interference, and lower propagation loss. In fact, it is commonplace for high-speed optical communications systems to have signal rates in the range of approximately several gigabits per second (Gbit/sec) to approximately several tens of Gbit/sec, and higher.

As is well known in the communication arts, transmission of information via a single channel has certain limitations. Increasing the data rate of a single channel is one strategy to increase the overall speed of the communications link. However, the rate at which information may be transmitted in a single channel eventually reaches a limit. One way to increase the available bandwidth is to use multiple channels. Typically in optical communication systems, the channels are wavelength channels where each individual channel has a center wavelength. Multiple wavelength channel systems are often referred to as being wavelength division multiplexed (WDM). Improvements in optical communication systems have resulted in WDM systems having a plurality of individual wavelength channels. In fact, due to the relatively narrow spacing in the optical channels needed to increase the overall bandwidth of the optical communication system, when four or more wavelength channels are implemented, the system is referred to as a dense wavelength division multiplexed system (DWDM).

In a DWDM system, a plurality of optical transmitters may be linked to a plurality of optical receivers along a common link. An example of a portion of a conventional DWDM system is shown in FIG. 1. A plurality of individual transmitters (TX1 . . . TXN) is implemented in the conventional scheme shown in FIG. 1. To this end, a first transmitter 101 (TX1) having a first wavelength channel (with center wavelength) is connected to a shared bus 102. A second transmitter 103 (TX2) having a second wavelength channel (with center wavelength λ₂) is also connected to shared bus 102. A host processor 104 is used to access the individual transmitters to write/read the information of each individual wavelength channel.

While the architecture shown in FIG. 1 has certain advantages, it has certain limitations and drawbacks. For example, the architecture shown in FIG. 1 is limited in its ability to be easily upgraded or expanded to handle a larger number of channels. For example, the architecture shown in the conventional system in FIG. 1 has limited expandability because it uses a direct access scheme. To wit, the host processor 104 directly accesses the transmitters TX1, . . . TXN. This can result in a lack of flexibility for the system designer. For example, as new or different devices and submodules are desired for the system, it may be useful to upgrade the system by replacing an existing transmitter module with a new transmitter module. In order for the system designer to upgrade/modify a transmitter module in the architecture shown in FIG. 1, access codes for the particular devices will have to be changed. Moreover, the memory addresses for each of the parameters of the transmitter module will also have to be corrected. Illustratively, if a system designer wanted to upgrade four single-channel transmitter modules (e.g., transmitter modules TX10-TX13) with a single four-channel subsystem, the designer would have to change the access code at the host processor 104 and determine the correct memory address of each of the variables/parameter of the four-channel subsystem which replaces the individual transmitters.

As can be appreciated, the upgrade of the hardware components in this conventional architecture requires a system-wide upgrade. Moreover, each time the system configuration is changed, this process must be repeated. This is time consuming and inefficient from the perspective of cost.

Finally, the number of channels the architecture of FIG. 1 can support is limited by the number of addresses the host processor 104 can handle because each channel requires its own physical address. As such, the channel capacity of the conventional architecture of FIG. 1 is limited.

Accordingly, what is needed, is an apparatus and method of accessing a variety of channels in a manner which overcomes at least the drawbacks of the conventional structures described above.

### SUMMARY OF THE INVENTION

According to an exemplary embodiment of the present invention, an optical apparatus includes a first bus having a plurality of modules connected thereto. At least one of the modules further includes at least one optical device which is connected to a second bus which is of the same protocol as the first bus.

According to another exemplary embodiment of the present invention, a method of accessing a plurality of optical devices includes providing a first access syntax to a host processor; and providing a second access syntax which translates the first access syntax. The second access syntax selectively enables access to the plurality of optical devices.

### BRIEF DESCRIPTION OF THE DRAWINGS

The invention is best understood from the following detailed description when read with the accompanying drawing figures. It is emphasized that the various features are not necessarily drawn to scale. In fact, the dimensions may be arbitrarily increased or decreased for clarity of discussion.

FIG. 1 is a schematic block diagram of a conventional transmitter architecture incorporating a single shared bus interface.

FIG. 2(a) is a schematic block diagram of a multi-channel subsystem architecture in accordance with an exemplary embodiment of the present invention.

FIG. 2(b) is a detailed view of the various components of one of the illustrative modules of the subsystem architecture of FIG. 2(a).

FIG. 2(c) is an example of a channel access table in accordance with an exemplary embodiment of the present invention.

FIG. 3 is a schematic block diagram of a subsystem architecture in accordance with another exemplary embodiment of the present invention.

FIG. 4 is an illustrative channel access table used in accordance with the exemplary subsystem architecture of FIG. 3.

FIG. 5 is a schematic block diagram showing the physical layer, media access (MAC) and client (network) layer of an optical subsystem architecture in accordance with an exemplary embodiment of the present invention.

FIG. 6 is a channel access table conversion flow chart in accordance with an exemplary embodiment of the present invention.

FIG. 7 is a flow chart of illustrative memory maps used in the channel access table in accordance with an exemplary embodiment of the present invention.

### DETAILED DESCRIPTION

In the following detailed description, for purposes of explanation and not limitation, exemplary embodiments disclosing specific details are set forth in order to provide a thorough understanding of the present invention. However, it will be apparent to one having ordinary skill in the art having had the benefit of the present disclosure, that the present invention may be practiced in other embodiments that depart from the specific details disclosed herein. Moreover, descriptions of well-known devices, methods and materials may be omitted so as to not obscure the description of the present invention.

Briefly, the present invention relates to a subsystem architecture and a method of access thereto for use in optical communication systems. According to an exemplary embodiment of the present invention, a shared bus interface has a plurality of modules connected thereto. A host processor is also connected to the shared bus interface. Each of the modules may include an internal shared bus interface, which is of the same protocol as the shared bus interface. Each of the modules may also include one or more individual devices which are connected to the internal shared bus interface. Illustratively, each module includes one or more of the individual channels of the system.

The host processor can access each individual channel via a channel access table (CAT) which translates a virtual access syntax into a physical access syntax. The apparatus and method of the exemplary embodiments of the present disclosure enable increased channel capacity, compatibility, design flexibility and the ability to upgrade a system or subsystem. The channel access table usefully enables the configuration of the physical access address at each channel.

As will become more clear as the description of the exemplary embodiments proceeds, changes in the hardware configuration of the architecture may be done almost transparently, with only slight modifications to the CAT table required to implement the changes in the hardware configuration. Moreover, because each individual channel does not require an individual physical address, a greater number of channels may be supported than in conventional direct access architectures described above.

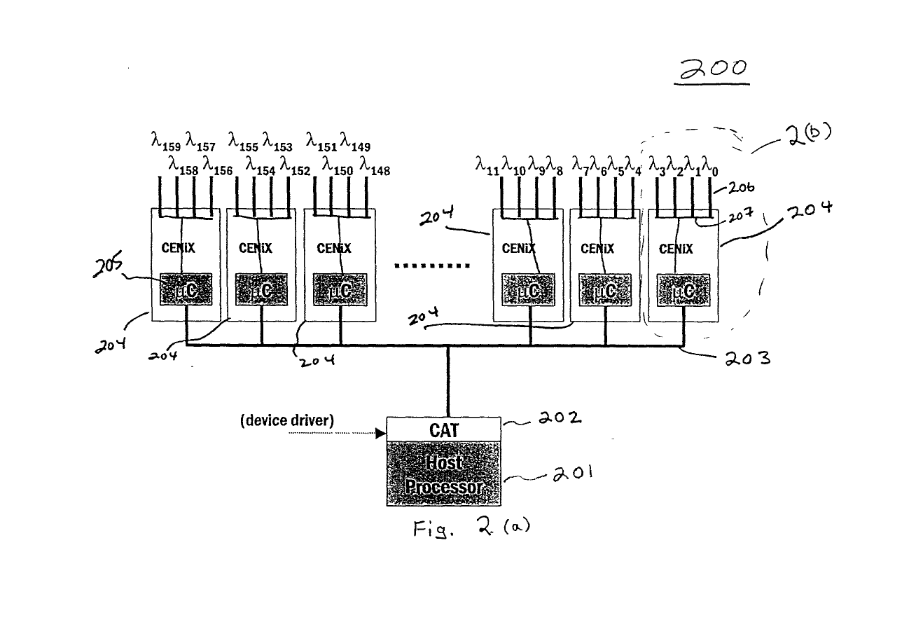

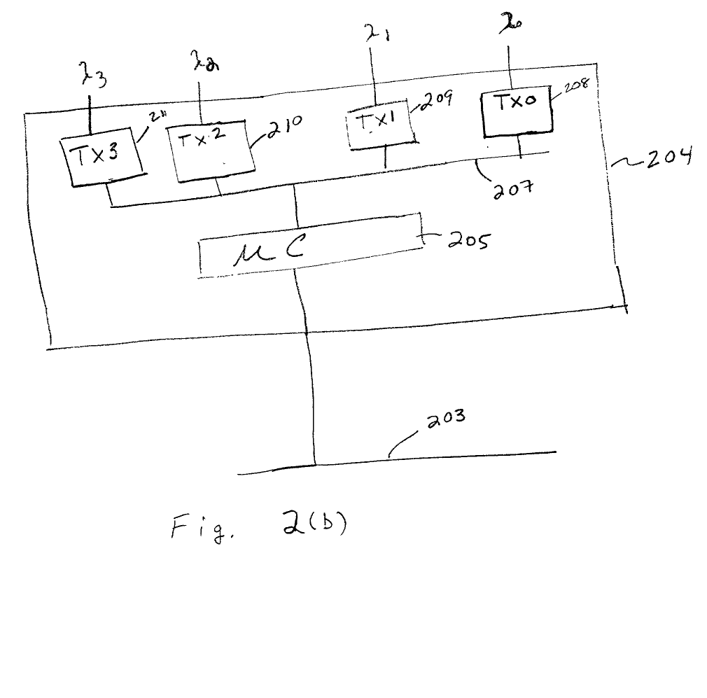

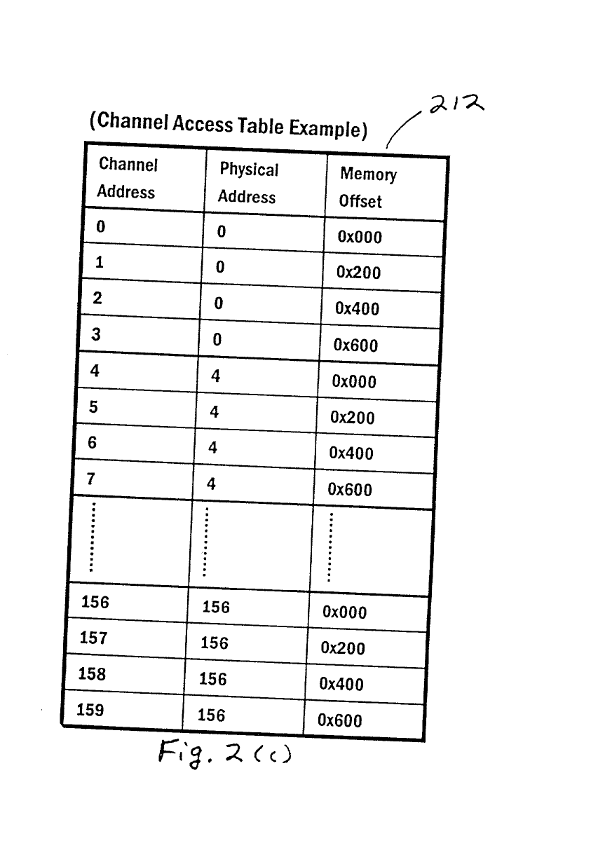

Turning to FIG. 2(a), an optical subsystem architecture 200 in accordance with an exemplary embodiment of the present invention is shown. The optical subsystem architecture 200 includes a host processor 201 which may include a channel access table (CAT) 202. The host processor 201 is connected to an address based shared bus interface 203. A plurality of modules 204 are each connected to the address based shared bus interface. Each of the plurality of modules includes a microcontroller 205 in the illustrative embodiment of FIG. 2(a). In general, the host processor 201 manages the overall network system level operations, and the communication with the attached subsystem modules 204. The microcontroller 205 in each module handles control settings and the alarm monitor of all subsystem level signals. Moreover, microcontroller 205 provides the communication interface between the modules 204 and their internal devices, and the host processor 201.

In the illustrative embodiment shown in FIG. 2(a), each of the modules includes four individual channel devices 206 which are connected to an internal shared bus interface 207. The address based shared bus interface 203 is illustratively a serial interface, for example an I²C, SPI, Ethernet or RS232 serial interface. Of course, these interfaces are merely illustrative of the present invention and other serial interfaces may be used for the address based shared bus interface 203. Likewise, the internal shared bus interface 207 of the individual modules may also be one of the above referenced serial interfaces, or another type of serial interface. Finally, in the exemplary embodiment shown in FIG. 2(a) the address based shared bus interface 203 and the internal shared bus interface 207 are of the same protocol. By using the same bus protocol for the address based shared bus interface 203 and the internal shared bus interface 207, the same individual channel devices used on address based shared bus interface 203 can also be used on internal shared bus interface 207. This is a useful advantage of have the same interface protocol between address based shared bus interface 203 and internal shared bus interface 207, as it allows the re-usage of same channel device(s) without changing the hardware and firmware design. Ultimately, this simplifies the hardware and firmware designers' tasks and ultimately lowers the overall design and implementation costs/complexity.

As can be appreciated, the dual-interface bus design incorporating the address based shared bus interface and internal shared bus interface affords a great deal of versatility and simplicity to the invention according to the illustrative embodiments described. For example, the dual-interface bus design separates the internal serial bus from the external serial bus so that the end user needs only one bus address. As will become more clear as the description of the exemplary embodiments proceeds this ultimately enables configuration changes in hardware that are transparent from the MAC layer and higher, and ultimately transparent to the end used. In fact, a change in hardware configuration requires a relatively straightforward modification of the CAT table, as opposed to changes in the access code in the Data Link layer or above that are necessary in conventional architectures.

Turning to FIG. 2(b), an illustrative subsystem module 204 in accordance with the exemplary embodiment shown in FIG. 2(a) is shown in enlarged view. To this end, the module 204 includes a first transmitter 208, a second transmitter 209, a third transmitter 210 and a fourth transmitter 211. For purposes of illustration of he present invention, the description that follows is centered on the interaction between the individual components of module 204, the host processor 201, and the addressed based shared bus 203. Of course, the interaction of other modules and individual components of a subsystem architecture in accordance with an exemplary embodiment of the present invention would be very similar. Such details, although not described particularly, are clearly within the scope of the present invention.

In the illustrative embodiment shown in FIG. 2(b), the transmitters are the individual transmitters of a DWDM system. Of course, this is merely illustrative, and as can be readily appreciated, other devices for use in other types of communication schemes may be used. For example, the individual devices may be transceivers, transponders or individual receivers, instead of or in addition to the illustrative transmitters. The internal shared bus interface 207 illustratively connects the individual transmitters to the microcontroller 205. The microcontroller 205 is then connected to the addressed based shared bus interface 203.

In the illustrative embodiment shown in FIG. 2(b), first transmitter 208 is for the wavelength channel having a center wavelength of λ₀; second transmitter 209 is for the wavelength channel having a center wavelength of λ₁,; third transmitter 210 is for the wavelength channel having a center wavelength λ₂; and fourth transmitter 211 is for the wavelength channel having a center wavelength λ₃. The wavelengths and bandwidth of the individual transmitters are illustratively in accordance with the international telecommunications union (ITU) grids.

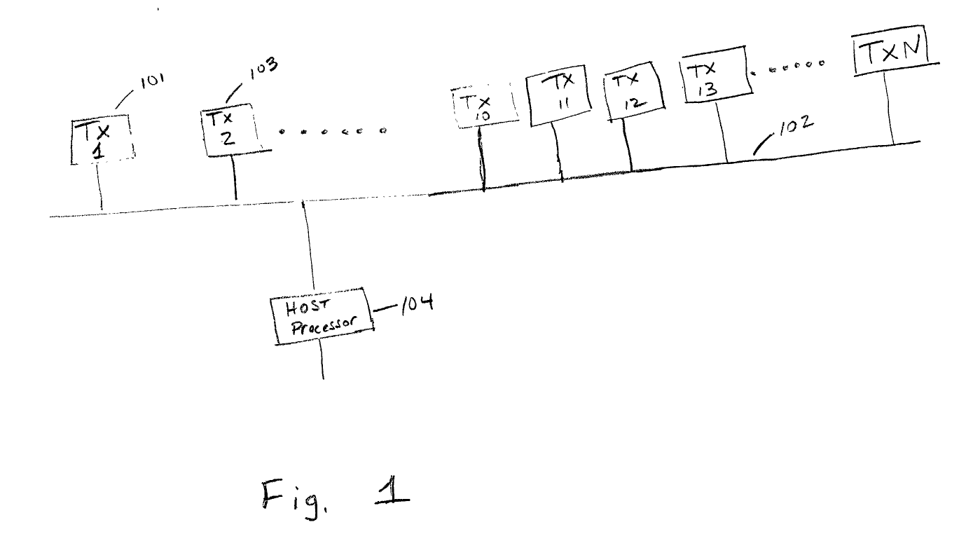

As described above, one particular useful aspect of the exemplary embodiment of the present disclosure is the channel access table. The CAT table is particularly advantageous because it allows the high-level network system (such as that shown in FIG. 1) to be directly ported onto the system architecture of FIG. 2(a) in a seamless manner. An example of a CAT table is shown in FIG. 2(c). The channel access table 212 illustratively includes the required information of: (1) all the individual channel addresses that host processor 201 needs to access; (2) the corresponding physical address for each channel address that host processor 201 will use to communicate with microcontroller 205; and (3) the adjusted memory address offset for individual channels 208, 209, 210 and 211 on the memory location of microcontroller 205.

The above information is needed to enable the transformation/communication of information between the address based shared bus and the individual channels/devices in the modules (e.g. addresses 0-159) for the illustrative 160 channel system. Moreover, the physical address for each channel is needed. Finally, the memory address offset is needed to enable the transformation of information to/from the individual channels via the microcontroller 205.

The channel access table of FIG. 2(c) is illustratively used in connection with the subsystem architecture 200 of the exemplary embodiment of FIG. 2(a). As mentioned briefly above, a virtual access syntax for the host processor 201 is used to enable access to one of the channels 206 of modules 204. This syntax is substantially identical to a single channel access such as that shown in FIG. 1 and is calculated by the host processor 201. Specifically, the virtual access syntax includes:

Channel Address [n]+Command+Memory Address+Data Bytes (1)

It is noted that the syntax of equation (1) is for the generalized cases when data is to be written to or read from channel n. The detailed access operation may vary from protocol to protocol, but should comprise with similar components, including channel address, command, memory address and data bytes.

The channel access table 212 is used to translate address, command and data information to one of the particular channels 206 of one of the submodules 204. To this end, a particular channel address has a particular physical address and a memory offset. This results in a physical access syntax after translation by the host processor 201 using the channel access table 212 of:

Physical Address [m]+Command+(Memory Address+Offset)+Data Bytes (2)

The syntax of equation (2) is a generalized format to illustrate the data access protocol. The physical access syntax enables the proper communication between the host processor and a particular channel.

Certain advantages are realized by virtue of implementation of the CAT table 212 and its implementation in subsystem architectures such as the illustrative architecture of FIG. 2(a). For example, the required number of access addresses (the physical address) is reduced from 160 in the case of a single (direct) channel access, to 40 in the present illustrative embodiment. However, the virtual number of channel addresses remains the same and available for the host processor. This results in a transparent transformation of the system to the system designers. Specifically, the CAT table 212 enables the original high-level network system code used in single channel access (such as that shown in FIG. 1) to be directly ported onto the system configuration shown of the illustrative embodiment of FIG. 2(a). The CAT table 212 stores the original (single channel access) channel address of each channel, the translated physical access address (physical address), and required memory offset to access the data of each channel. This fosters a simpler design, and enables the modularity, interchangeability and the ability to upgrade the system as referenced above.

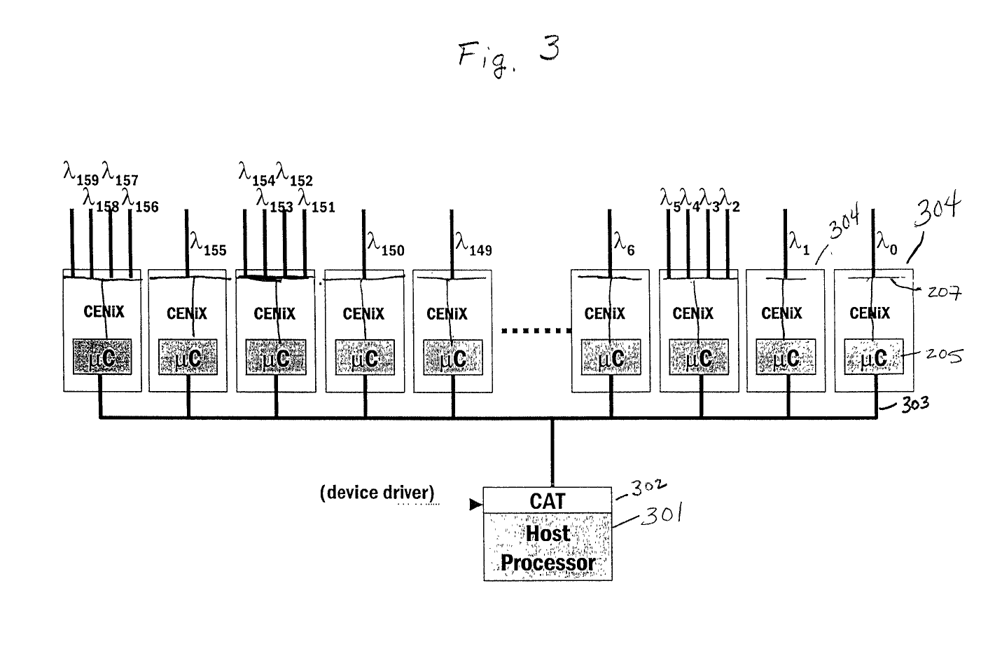

As referenced above, the invention in accordance with the exemplary embodiments of the present disclosure enables a great deal of versatility and adaptability in subsystem architecture design for optical communications applications. One such exemplary embodiment of the present invention is shown in FIG. 3. In accordance with the exemplary embodiment shown in FIG. 3, host processor 301 has a channel access table 302 included therein. The host processor 301 is connected to an address based shared bus interface 303, which is substantially the same as the address based shared bus interface described in connection with the illustrative embodiment shown in FIG. 2(a). A plurality of modules 304 are also connected to the address based shared base interface 303. As described in connection with the illustration embodiment shown in FIG. 2(a), the individual modules 304 may each include an internal bus (not shown), which is connected to a microprocessor (not shown). The modules 304 shown in FIG. 3 are substantially the same as those described in connection with the exemplary embodiment of FIG. 2(a), and as such, only the distinctions will be described in detail.

As referenced previously, one particular advantage of the architecture of the invention of the present disclosure is the ability to readily adapt and change the configuration of the individual modules 304. In the exemplary embodiment shown in FIG. 3, some of the modules 304 include a plurality of channels (e.g., channels 2-5 having center wavelengths λ₂-λ₅ are disposed in one of the modules 304) while other modules 304 may only include one channel (e.g. channel 1 having center wavelength λ₁ is the only channel its individual module). Of course, these numbers are also arbitrary, and clearly the modules 304 may include other numbers of channels. Moreover, the individual submodules 304 of the illustrative embodiment of FIG. 3 may also include a variety of devices. To this end, like the submodules shown in FIG. 2(b), the individual modules 304 may include a plurality of transmitters, or other devices described above.

The versatility and ability to readily upgrade the configuration that is afforded the system designer by virtue of the present invention is a result of the apparatus and method of the illustrative embodiments of the present invention and the fungibility of the various components used in the submodules. For purposes of illustration, the reconfiguration of the architecture shown in FIG. 2(a) to the architecture shown in FIG. 3 is presently described. Although the architecture shown in the illustrative embodiment of FIG. 3 differs in its configuration when compared to the illustrative embodiment of FIG. 2(a), it does not require a great deal of effort on the part of the subsystem designer to implement by virtue of the present invention. Contrastingly, as described above, in conventional multi-channel subsystems, a subsystem designer would have to undergo a significant effort to change the access codes and determine the correct memory address of each of the parameters/variables of the individual components of the submodule. After the alteration of the hardware to arrive at the architecture shown in FIG. 3, the only other change that would have to be made would be that updating the channel access table. This is a relatively straightforward manipulation to effect a configuration change.

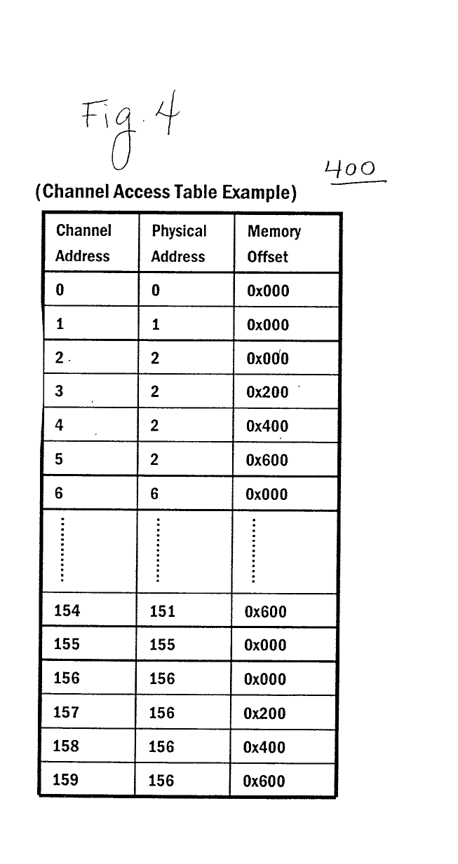

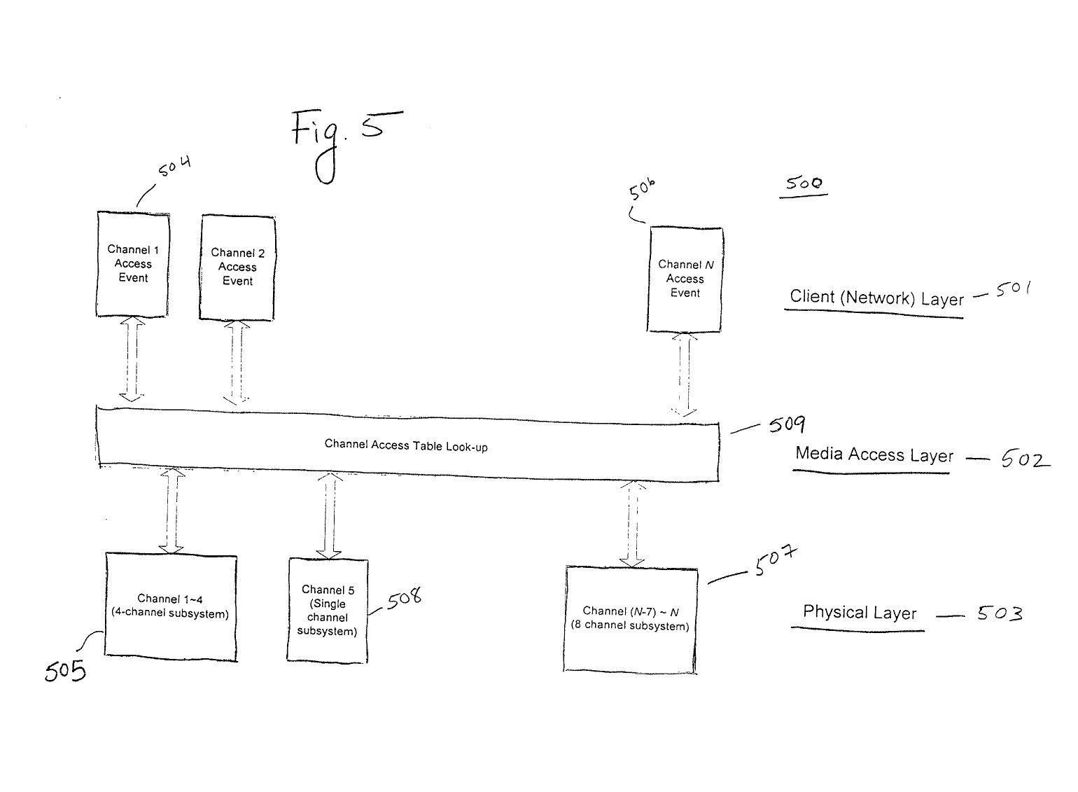

The channel access table 400 shown in FIG. 4 is used to support the architecture of the illustrative embodiment of FIG. 3. As can be appreciated through a review of the architectures shown in FIGS. 2(a) and 3, and a comparison of their respective CAT tables 212 and 400, changing the architecture shown in FIG. 2(a) to that shown in FIG. 3 requires a rather simple modification of the CAT table 212 to realize CAT table 400. For example, while Channel 1 in the illustrative embodiment of FIG. 2(c) had physical address “0”, in the illustrative embodiment of FIG. 3, Channel Address 1 now has Physical Address 1. The memory offset is changed as needed to effect the translation arriving at the physical access syntax. As such, the change in configuration between the architecture shown in the illustrative embodiment of FIG. 2(a) and that of FIG. 3 requires only a slight manipulation of the channel access table to reflect the configuration. This is a particularly advantageous aspect of the present invention because any change in the architecture configuration does not require any change in syntax from network layer 2 (Media Access and Data Link layer) and up to layer 7 (Application layer) in an Open System Interconnection (OSI) model definition. These and other advantages are described more fully in connection with the exemplary embodiment of FIG. 5.

Once the CAT table 400 is determined, the physical access syntax can be determined. The virtual access syntax for the host processor 301 to access data from data channel (n) remains the same. As such, the same syntax as used in the single channel access may be used. Again, this is given by:

Channel Address [n]+Command+Memory Address+Data Bytes (1)

The physical access syntax after table translation is again given by:

Physical Address [m]+Command+(Memory Address+Offset)+Data Bytes (2)

As can be readily appreciated from the above-described exemplary embodiments, a plurality of configurations may be implemented in accordance with the exemplary embodiment of the present invention, with reconfigurations and adaptations requiring only a straight-forward charge in the CAT table. Ultimately, this enables subsystem vendors to design a multi-channel subsystem using the same serial interface as a single-channel transmitter or other device, and be able to re-use the same transmitter (or other device) inside the multi-channel subsystem motherboard.

One other advantage of this dual interface architecture of the exemplary embodiments of the present invention is the decoupling of the reliability of the individual channel devices from the host processor (e.g. host processor 301). Therefore, if different channel devices have to be used in subsystem module (e.g. module 204), they can be transparently substituted/added with respect to the host processor 301, as long as the microcontroller (e.g. microcontroller 205) compiles the parameters of each individual channel in the same memory address mapping as the original channel device (e.g. device 206). This feature enables increased versatility in network configuration design.

FIG. 5 shows a schematic block diagram of a virtual channel access architecture 500 in accordance with an exemplary embodiment of the present invention. Specifically, the virtual channel access architecture 500 includes the client/network layer 501, the media access (MAC) layer 502 and the physical layer 503. The client/network layer 501 is layer 3 in the OSI model definition, which provides routing and interconnections setup between networks. The media access layer 502 is layer 2 in the OSI model definition, which defines the data access methods and protocols. The MAC layer 502 includes a channel access table, a host processor, and an address based shared bus interface such as those described in connection with the exemplary embodiments above. The physical layer includes the physical hardware used to transmit and receive data signals in the transmission channels. The physical layer includes the subsystem modules and shared bus interfaces as described previously.

A channel access event such as Channel 1 Access Event 504 is interfaced with the address based shared bus interface in the MAC layer 502 (not shown). The channel access table 509 results in the translation of the virtual access syntax from the Channel 1 Access Event 504. Again, this syntax is identical to a single channel access. After translation by the channel access table 509, the particular Channel 1 Event is communicated to the {Channel 1-4} module 505. Similarly, Channel (n) Access Event 506 would be ultimately communicated to {Channel (n-7)-Channel (n) module} 507. In the particular access event scheme shown in FIG. 5, Channel 5 module 508, which is a single channel substrate, is not accessed, as there is not Channel 5 Access Event.

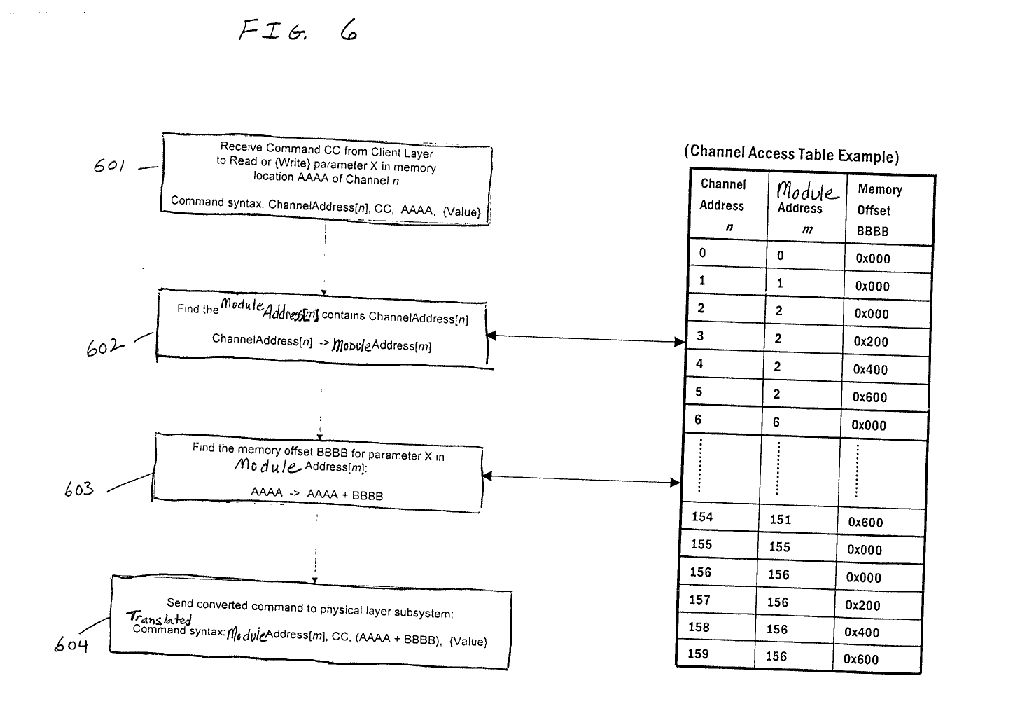

The access event communication (e.g. Channel 1 Access Event) of the virtual channel access architecture may be effected using the illustrative channel access table conversion flowchart shown in FIG. 6. At 601, a receive command CC at the client/network layer is received. This is a channel access event. The illustrative command CC is to read or write a particular parameter, x, in memory location AAAA of channel (n). The virtual access syntax (also referred to as the Command Syntax in this embodiment) is given by:

Virtual Access Syntax: Channel Access (n), CC, AAAA, {value}

where {value} is the particular value of the parameter, x. The parameter, x, may be one of a variety of input/output parameters of a particular device located in a particular module. For example, it may be the temperature of the transmitter of channel n.

Next, the module address which contains channel address (n) is determined as shown at 602. This determination is made using the exemplary channel access table shown in FIG. 6. Next, as shown at 603, a memory offset, BBBB, for the particular parameter x in module address m is determined. Again, this is used using the memory offset of the channel access table. Finally, the converted or translated command is sent to the physical layer subsystem as shown at 604. The physical access syntax (also referred to as the translated command syntax in the present embodiment) is given by:

Physical Access Syntax: Module Address (m), CC, (AAAA+BBB), {value}

As such, the command from the client/network layer 501 is transparently translated via the CAT 509 of media access layer 502, and is communicated to the physical layer 503 in accordance with the exemplary embodiment of the present invention.

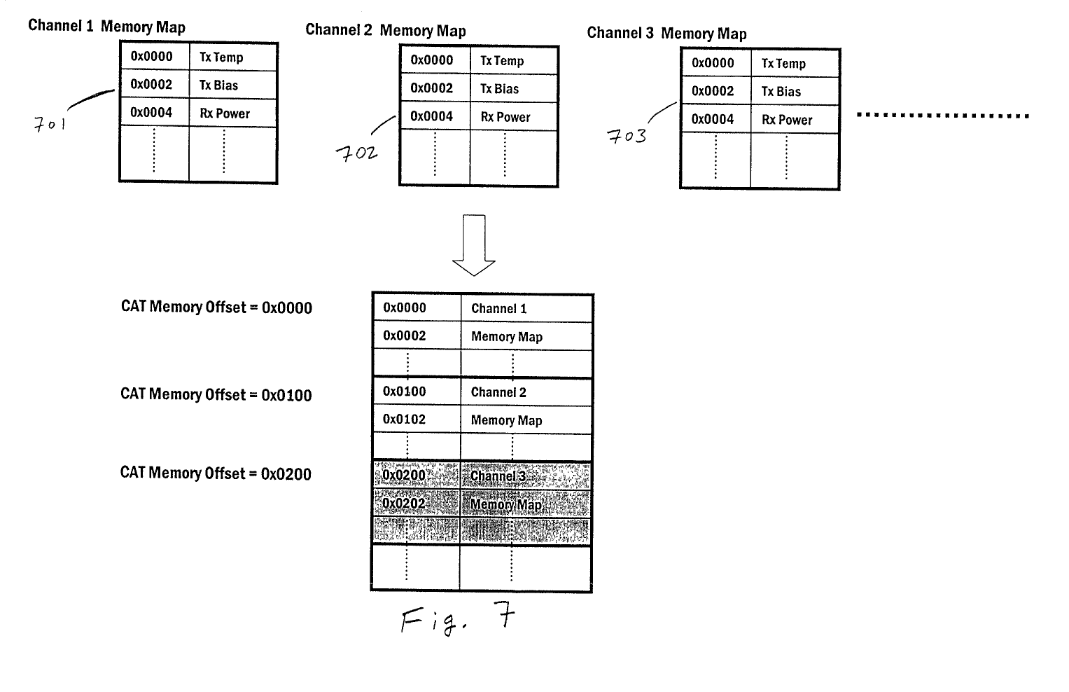

Turning to FIG. 7, a useful aspect of the translation to convert a particular command to the physical layer subsystem is shown. In particular, the memory map for various channels which is incorporated in the memory offset of the channel access table is shown. Channel one memory map 701 includes a variety of parameters such as the transmitter temperature (Tₓ Temp) the transmitter bias current level (Tₓ Bias) the receiver power level (Rₓ Power), etc. Each of these various parameters is given a particular memory address. For example, the transmit temperature is given the address 0x000 while the transmitter bias is given the address 0x0002. Likewise, channel two memory map 702 and channel three memory map 703 have similar memory addresses for the various parameters. Each of the memory maps 701, 702, 703 are offset by a particular memory offset value. For example, the memory offset for channel 1 is 0x000. The memory offset for channel two is 0x0100, and the memory offset for channel three is 0x0200. Of course, this continues for the channels up to channel n. For example, in the illustrative channel access table of FIG. 6, there are 159 channel addresses.

The channel memory offset for each particular channel then the particular offset of the parameters in the various memory maps for the individual channels as described above. As such, the offset may be used in the configuration of the CAT table to enable read/write capability for the various parameters pursuant to a particular received command from the client/network layer 501 shown in FIG. 5.

As can be appreciated from a review of the above description of the exemplary embodiments of the present invention, the virtual access design of the present invention is particularly beneficial to system designers. For any combination of single-channel subsystems and multi-channel subsystems in an optical communication system, the system designer can completely reconfigure a system or subsystem in hardware (at the physical layer) and merely update the CAT table to reflect the change in the hardware configuration. This usefully reduces the engineering time and costs due to the configuration modification. Moreover, system designers may use any combination of single-channel or multi-channel subsystems without having to modify the access code in the data link layer or any layer there above up to application layer (layer 7), in the optical communication architecture. Instead, a relatively straightforward update in the channel access table in the MAC layer may be effected for the changed configuration.

Moreover, in accordance with the illustrative embodiments of the present invention, a greater number of channels may be accommodated and/or integrated in an efficient manner. To this end, because only the physical address of the multi-channel subsystem is used for channel access, more channels may be added to a particular system. Illustratively, if there are 40 addresses available to a host processor, up to 160 channels may be accessed with a forty 4-channel subsystems (e.g., a subsystem such as that shown in FIG. 2(a)). This is a sharp improvement over a single-channel system using a single address based shared bus interface, as the same host processor would only be able to access 40 channels. Again, this is a direct result of the dual interface bus and CAT of the virtual access design of the exemplary embodiments of the present invention. Ultimately, the modular system design of the illustrative embodiments of the present invention enable multi-channel integration at the subsystem level in a manner which enables compatibility, adaptability, flexibility, simplicity, and the ability to readily upgrade with relatively minor changes in the software.

The invention having been described in detail in connection through a discussion of exemplary embodiments, it is clear that modifications of the invention will be apparent to one having ordinary skill in the art having had the benefit of the present disclosure. Such modifications and variations are included in the scope of the appended claims.

I claim:

1. An optical apparatus comprising:
a first bus having at least one subsystem module connected thereto, said at least one subsystem module having at least one optical device which is connected to a second bus of the same protocol as said first bus.

2. An optical apparatus as recited in claim 1, further comprising a host processor which is connected to a channel access table.

3. An optical apparatus as recited in claim 2, wherein said channel access table includes a plurality of individual channel addresses, corresponding physical addresses for each of said plurality of individual channel addresses, and a memory address offset for each of a plurality of individual channels.

4. An optical apparatus as recited in claim 1, wherein each of said at least one submodules further includes a microcontroller.

5. An optical apparatus as recited in claim 3, wherein said first bus is an address based shared bus interface.

6. An optical apparatus as recited in claim 5, wherein said host processor is connected to said address based shared bus interface.

7. An optical apparatus as recited in claim 5, wherein said address based shared bus interface is a serial interface.

8. An optical apparatus as recited in claim 1, wherein said second bus is an internal shared bus interface.

9. An optical apparatus as recited in claim 1, wherein said same protocol is chosen from the group consisting essentially of the I²C protocol, the SPI protocol, the Ethernet protocol and the RS232 protocol.

10. An optical apparatus as recited in claim 2, wherein said host processor calculates a virtual access syntax which includes a channel address, a command, a memory address and data bytes.

11. An optical apparatus as recited in claim 3, wherein said host processor calculates a physical access syntax using said channel access table.

12. An optical apparatus as recited in claim 11, wherein said physical access syntax includes a physical address, a command, a memory address and offset, and data bytes.

13. An optical apparatus as recited in claim 1, wherein said at least one subsystem module further comprises a plurality of subsystem modules.

14. An optical apparatus as recited in claim 13, wherein at least one channel is connected to each of said plurality of subsystem modules.

15. An optical apparatus as recited in claim 1, wherein said at least one optical device is chosen from the group consisting essentially of transmitters, receivers, transceivers and transponders.

16. A method of accessing a plurality of optical devices, the method comprising:
translating a channel address to a physical access address with a memory offset.

17. A method as recited in claim 16, wherein said translating further comprises using a channel access table.

18. A method as recited in claim 16, wherein said channel address is used by a host processor to calculate a virtual access syntax.

19. A method as recited in claim 18, wherein said physical access address is used by said host processor to calculate a physical access syntax.

20. A method as recited in claim 19, wherein said host processor accesses a channel access table to calculate said physical access syntax.

21. A method as recited in claim 1, wherein the plurality of optical devices are disposed in at least one submodule, and said submodule includes a bus which has a protocol that is the same as a protocol of another bus to which a host processor is attached.

22. A method as recited in claim 17, wherein said channel access table further comprises a plurality of individual channel addresses, corresponding physical addresses for each of said plurality of individual channel addresses, and a memory address offset for each of a plurality of individual channels.

23. A method as recited in claim 21, wherein each of said at least one submodules includes a microprocessor which communicates said physical access syntax to said plurality of optical devices.

24. A method as recited in claim 16, wherein a host processor performs said translating.

25. A method as recited in claim 16, wherein the accessing further comprises reading data from said plurality of optical devices.

26. A method as recited in claim 16, wherein the accessing further comprises writing data to said plurality of optical devices.

27. A method as recited in claim 16, wherein said plurality of optical devices are part of a wavelength division multiplexed communication system.
